(19) United States
(12) Patent Application Publication
(10) Pub. No.: US 2025/0121756 A1
(43) Pub. Date: Apr. 17, 2025

(54) VALVE FOR A VEHICLE SEAT COMFORT SYSTEM

(71) Applicant: Faurecia Autositze GmbH, Hannover (DE)

(72) Inventor: Piotr Ceglarek, Katowice (PL)

(73) Assignee: Faurecia Autositze GmbH, Hannover (DE)

(21) Appl. No.: 18/912,930

(22) Filed: Oct. 11, 2024

(30) Foreign Application Priority Data
Oct. 16, 2023 (DE) 102023128307.3

(51) Int. Cl. B60N 2/70

(52) U.S. Cl. CPC B60N 2/7088

(57) ABSTRACT

A valve, preferably a solenoid valve, for a seat comfort system, preferably a vehicle seat comfort system, which in particular comprises at least one fluid actuator, or/and a seat, preferably a vehicle seat, which is equipped with such a comfort system, comprises a base body with a linearly movable piston. The piston is reversibly displaceable in the direction of a sealing seat and in the direction of an end stop. The piston has at least one damping element provided for mitigating its impact on the end stop or/and on the sealing seat. The piston has a channel extending through it between its two end-face regions. The damping element is arranged within this channel.

### CROSS REFERENCE TO RELATED APPLICATIONS

This patent application claims the benefit of and priority on German Patent Application No. 10 2023 128 307.3 having a filing date of 16 Oct. 2023.

### BACKGROUND OF THE INVENTION

### Technical Field

The invention relates to a preferably pneumatic valve, preferably a solenoid valve, for a seat comfort system, preferably a vehicle seat comfort system, which preferably comprises at least one fluid actuator, or/and to a seat, preferably a vehicle seat, which is equipped with such a comfort system, which in particular comprises at least one fluid actuator, or/and a seat, preferably a vehicle seat, which is equipped with such a comfort system, comprising a base body with a linearly movable piston, which is reversibly displaceable in the direction of a sealing seat and in the direction of an end stop, wherein the piston has at least one damping element provided for mitigating its impact on the end stop or/and on the sealing seat, and/or to a valve, preferably solenoid valve, for a seat comfort system, preferably a vehicle seat comfort system, which preferably comprises at least one fluid actuator, or/and a seat, preferably a vehicle seat, which is equipped with such a comfort system, comprising a base body with a linearly movable piston, which is reversibly displaceable by means of a clamping force into a closed position pressing the piston against a sealing seat and, for reaching an open position, by means of an electromagnetic drive against the clamping force in the direction of an end stop, wherein the piston has at least one damping element provided for mitigating its impact on the end stop or/and on the sealing seat, which damping element protrudes relative to an end-face region of the piston to form an annular gap spacing the piston in its closed position away from the sealing seat or/and in its open position away from the end stop.

### Prior Art

Especially seats used in vehicles often have adjustment functions that go beyond the usual inclination and height adjustment. This makes it possible, for example, to ergonomically adapt at least one seat area to a person who comes into contact therewith, in order to increase their comfort. A corresponding function device can, for example, be arranged as a lumbar support in the backrest of a seat. In addition to other equipment features, such as seat heating, a massage system can alternatively or additionally be integrated in order to allow the back muscles to relax preferably on longer trips. Actuators generate the necessary movement sequences. Their manipulation can be carried out purely electrically or—preferably in order to obtain the shortest possible response times—by manipulating a fluid pressure within the fluid actuators acting in the sense of a bladder, in order to specifically change their volume. The control of a fluid actuator requires at least one valve in order to ensure rapid switching of the fluid flow(s).

The valves used for this purpose each comprise a base body, in which a linearly movable piston is mounted. Depending on its variable position, the piston is used to open or close the valve. Usually, the piston can be held by a preferably mechanically generated clamping force in a closed position, in which it is pressed against a sealing seat. For example, by means of a preferably electromagnetic drive, it is possible, in order to reach an open position, to reversibly displace the piston in the direction of an end stop against the clamping force acting on it, in order to open the valve. The end stop is essentially used to limit the linear mobility of the piston. Depending on the design, the path of the piston as regards its displaceability can be influenced by a possible adjustability of the end stop. Since the components that move relative to one another are generally made of hard materials, such a valve emits operating noises, which can be described as clicking noises, as soon as the moving piston is abruptly braked by striking the end stop and/or sealing seat. In order to mitigate the impact of the piston, at least one, preferably elastic, damping element that is softer than the other components is sometimes provided on the end stop or/and the sealing seat.

U.S. Pat. Nos. 3,593,241 A and 8,342,479 B2 each disclose a solenoid valve with a damping element, which is arranged at an end of the piston facing the sealing seat and completely covers the end-face region thereof.

US 2019/0219188 A1 also discloses a solenoid valve with damping elements, which are each located on an end portion of the piston. The damping element facing the sealing seat is arranged within the associated end portion, while the damping element facing the end stop is provided on the end-face region of the associated end portion. The damping elements are designed such that they protrude relative to the respectively associated end-face region of the piston in each case to form an annular gap that spaces the piston in its closed position away from the sealing seat.

Due to the quasi shortening of the piston, which is spaced away from the sealing seat by the damping element to form the annular gap, on the one hand the magnetic field that can be generated by the electromagnetic drive is weakened, or the force of the electromagnetic drive used to displace the piston is reduced. On the other hand, the particular and different arrangement of the damping elements in the region of the two ends of the piston is accompanied by a corresponding effort in terms of production.

### BRIEF SUMMARY OF THE INVENTION

The invention is based on the object of developing a valve to the extent that it can be produced cost-effectively despite the arrangement of at least one damping element on the piston and makes it possible to maintain a strong magnetic field inside the solenoid valve.

This object is achieved by a preferably pneumatic valve, preferably a solenoid valve, for a seat comfort system, preferably a vehicle seat comfort system, which in particular comprises at least one fluid actuator, or/and a seat, preferably a vehicle seat, which is equipped with such a comfort system, comprising a base body with a linearly movable piston, which is reversibly displaceable in the direction of a sealing seat and in the direction of an end stop, wherein the piston has at least one damping element provided for mitigating its impact on the end stop or/and on the sealing seat, characterized in that the piston has a channel extending through it between its two end-face regions, wherein the damping element is arranged within this channel.

This object also is achieved by a pneumatic valve, preferably solenoid valve, for a seat comfort system, preferably a vehicle seat comfort system, which preferably comprises at least one fluid actuator, or/and a seat, preferably a vehicle seat, which is equipped with such a comfort system, comprising a base body with a linearly movable piston, which is reversibly displaceable by means of a clamping force into a closed position pressing the piston against a sealing seat and, for reaching an open position, by means of an electromagnetic drive against the clamping force in the direction of an end stop, wherein the piston has at least one damping element provided for mitigating its impact on the end stop or/and on the sealing seat, which damping element protrudes relative to an end-face region of the piston to form an annular gap spacing the piston in its closed position away from the sealing seat or/and in its open position away from the end stop, characterized by at least one compensating element designed to partially bridge the annular gap, such that, with respect to the longitudinal direction of the piston, the length of a portion of the damping element protruding relative to the preferably associated end-face region of the piston is less than a width of the preferably associated compensating element.

Advantageous embodiments can be found in the dependent claims.

The invention proposes that the piston has a channel extending through it between its two end-face regions, wherein the damping element is arranged within this channel.

The resulting advantage is that the piston has just one damping element, while its impact-mitigating properties are at the same time available in the region of its two ends. In other words, it is no longer necessary to arrange and/or form two separate damping elements on the piston since the cost-effective arrangement according to the invention of a single damping element within the channel is sufficient to achieve the same effect. At the same time, the damping element is used to seal the sealing seat at least in the region thereof as soon as the piston is pressed against the sealing seat.

According to an advantageous development of the idea underlying the invention, at least one end-side portion or both end-side portions of the damping element can protrude relative to the in particular respectively associated end-face region of the piston. In this way, it is possible to prevent the components, which are hard as regards their material, from colliding with one another when the piston moves, since the protruding portion(s) of the damping element are used to space the components apart as they approach one another. The spacing is carried out by forming, in particular in each case, an annular gap which spaces the piston, preferably in its closed position, away from the sealing seat or/and, preferably in its open position, away from the end stop.

Preferably, the piston can be reversibly displaceable by a preferably electromagnetic drive against the clamping force in the direction of the end stop for reaching an open position and, preferably by the clamping force, in the direction of the sealing seat for reaching a closed position.

Advantageously, at least one compensating element designed to partially bridge the annular gap can be provided such that, with respect to a longitudinal direction of the piston, the length of a portion of the damping element protruding relative to the in particular associated end-face region of the piston is less than a width of the in particular associated compensating element. This ensures that the components, which are hard as regards their material, do not collide with one another when the piston moves, since the protruding portion(s) of the damping element space them away from one another.

The object is also achieved by a valve whose piston has at least one damping element provided for mitigating the impact of the piston on the end stop or/and on the sealing seat, which damping element protrudes relative to an end-face region of the piston to form an annular gap spacing the piston in its closed position away from the sealing seat or/and in its open position away from the end stop. According to the invention, the arrangement of at least one compensating element designed to partially bridge the annular gap is proposed. This means that, with respect to a longitudinal direction of the piston, the length of a portion of the damping element protruding relative to the preferably associated end-face region of the piston is less than a width of the preferably associated compensating element.

By arranging the compensating element according to the invention, which is used to partially bridge the annular gap, it is possible to maintain the strongest possible magnetic field inside the valve.

According to a preferred development of the basic inventive concept, at least part of the compensating element(s) can be arranged or formed on the piston. This can, for example, be done by arranging the compensating element on the end-face region of the piston or/and by correspondingly lengthening a part of the end-face region of the piston.

Alternatively or additionally, at least part of the compensating element(s) may be arranged or formed on the sealing seat of the valve.

Further alternatively or additionally, at least part of the compensating element(s) can be arranged or formed on the end stop.

The most suitable arrangement of the compensating element(s) can result from the structure of the electromagnetic drive, preferably from the position and/or dimensions of its coil to which a voltage can be applied.

In principle, alternatively or additionally, it may be provided that at least part of the compensating element(s) is/are designed as a preferably separate component in each case.

Within the scope of the invention, it is preferred that the compensating element(s) can preferably each be ring-shaped. Of course, it is also preferably conceivable in the case of an arrangement on one of the existing components that the compensating element(s) can also be formed, for example, by individual and thus spaced-apart elements which do not have a common shaping connection with one another.

Advantageously, the protruding portion(s) of the damping element may be unsupported on the circumference. This means that a protruding portion of a damping element has the possibility of freely deforming radially when a compressive force acts on it, in order to reduce the impact noise as much as possible by means of its elastic radial deformability. This is not the case, for example, if the protruding portion of a damping element is too short so that its otherwise possible radial deformability is prevented by an opening within the piston that accommodates the damping element. Particularly preferably, the protruding portion of a damping element may be unsupported all the way around.

In principle, it is considered advantageous within the scope of the invention if the damping element is arranged or formed within the piston, wherein its protruding portion(s) is/are located outside the piston.

The damping element can preferably be introduced as an initially shapeless material into a channel of the piston, where it then preferably hardens elastically.

The compensating element(s) can at least partially be formed from or comprise a metallic material. Particularly preferably, the compensating element(s) may at least partially be formed from or comprise a ferromagnetic material. Whatever the case, the maintenance of a strong magnetic field inside the valve can be significantly improved by the appropriate choice of material or material combination.

In principle, it is provided that the compensating element(s) may be a one-piece component of the piston made of the same material. For example, a compensating element can be formed on the piston by machining.

Alternatively or additionally, the compensating element(s) may be a one-piece component of the sealing seat made of the same material. For example, a compensating element can be formed on the sealing seat by machining.

Further alternatively or additionally, the compensating element(s) may be a one-piece component of the end stop made of the same material. For example, a compensating element can be formed on the end stop by machining.

Preferably, the clamping force acting on the piston can be generated by a spring element, preferably a helical spring.

Particularly preferably, the piston may have a channel, which extends through it between its two end-face regions and within which the damping element is arranged in this case.

Advantageously, the piston can have an access, which is connected to the channel, in particular arranged on the circumference, and through which the damping element is introduced as an initially shapeless material. For this purpose, the access can preferably be located such that it is equally spaced away from the two end-face regions of the piston. Particularly preferably, the material can completely fill the channel. Due to the access, an even distribution of the initially shapeless material within the channel is achieved, which significantly simplifies the production of the damping element and at the same time its fastening within the piston.

According to a particularly preferred development, the channel of the piston can widen toward at least one, preferably both, end-face region(s) of the piston. In other words, the channel can substantially have the shape of a bone. In this way, in particular after the material has hardened, a positive connection is created between the piston or its channel and the damping element. Due to the resulting thickenings toward both ends of the damping element, the damping element sits firmly within the piston, which makes otherwise additionally necessary, usually adhesive, connections between the damping element and the piston superfluous.

Preferably, the initially shapeless material can be injected into the channel of the piston and hardened there. Any shrinkage during hardening of the damping element can contribute to the damping element converting a great deal of energy into, in particular radial, deformation during impact on the sealing seat or/and the end stop, so that the operating noise of the valve can be further reduced.

In principle, at least in some regions, the material of the damping element can, for example, consist of rubber or/and silicone or comprise the materials mentioned. In any case, the material is an elastic material, on which the damping properties of the damping element are based. The geometry of the damping element can be symmetrical or asymmetrical, in particular with respect to the longitudinal direction of the piston or/and perpendicular thereto.

The valve according to the invention, preferably a solenoid valve, makes it possible to maintain the strongest possible magnetic field inside the valve despite the arrangement of at least one damping element on the piston and its thus quasi shortening.

Furthermore, the invention is aimed at a seat comfort system, preferably a vehicle seat comfort system, and at a seat, preferably a vehicle seat, with such a comfort system, which comprises at least one fluid actuator and at least one valve according to the invention as described in more detail above.

The advantages resulting therefrom have already been explained in more detail in connection with the introduction of the valve according to the invention so that reference is made at this point to the previous explanations in this respect in order to avoid repetition.

### BRIEF DESCRIPTION OF THE DRAWINGS

The invention is explained in more detail below with reference to a few exemplary embodiments schematically shown in the drawings.

FIG. 1 shows a valve according to the invention as an exploded drawing in a side view.

FIG. 2 shows a component of the valve from FIG. 1 in a longitudinal section.

FIG. 3A shows the valve from FIG. 1 in the assembled state in a longitudinal section in a first switching position.

FIG. 3B shows the valve from FIG. 1 in the assembled state in a longitudinal section in a second switching position.

FIG. 4 shows the component from FIG. 2 in a first alternative embodiment in an otherwise identical representation.

FIG. 5 shows the component from FIG. 2 in a second alternative embodiment in an otherwise identical representation.

### DETAILED DESCRIPTION OF PREFERRED EMBODIMENTS

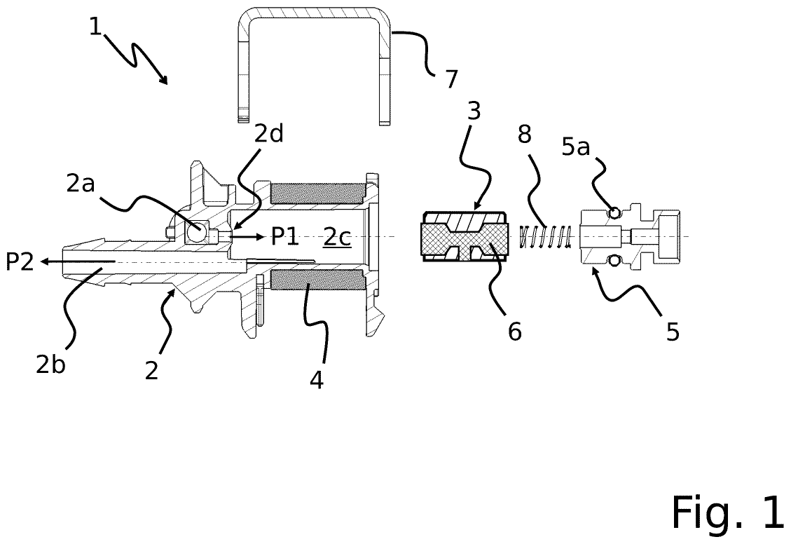

FIG. 1 shows a valve 1 according to the invention as an exploded drawing in a side view. The valve 1 comprises a base body 2, which in the present case has, purely by way of example, a first opening 2a and a second opening 2b. The two openings 2a, 2b can each be connected to a fluid line, which is not shown in detail here. In this way, a fluid pressure can, for example, be applied to the first opening 2a. In the open state of the valve 1, the fluid can flow out through a part of the base body 2 via the second opening 2b. In a manner not shown in detail, the second opening 2b can be connected to a fluid actuator in order to control said fluid actuator.

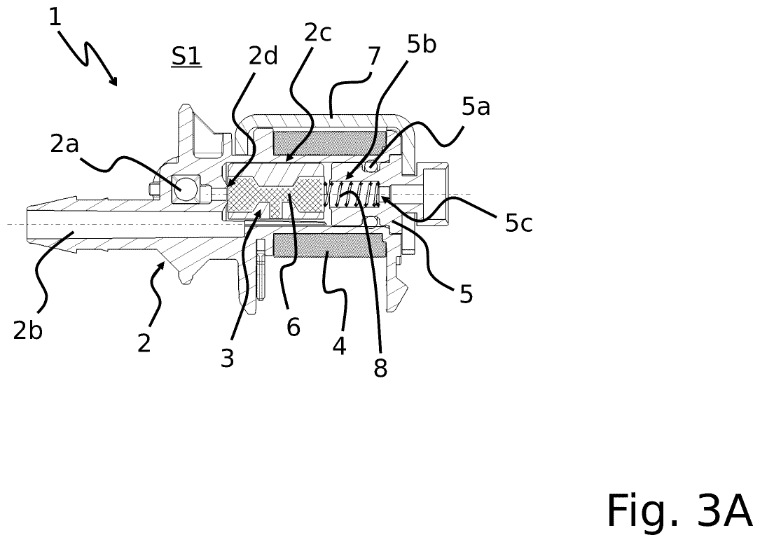

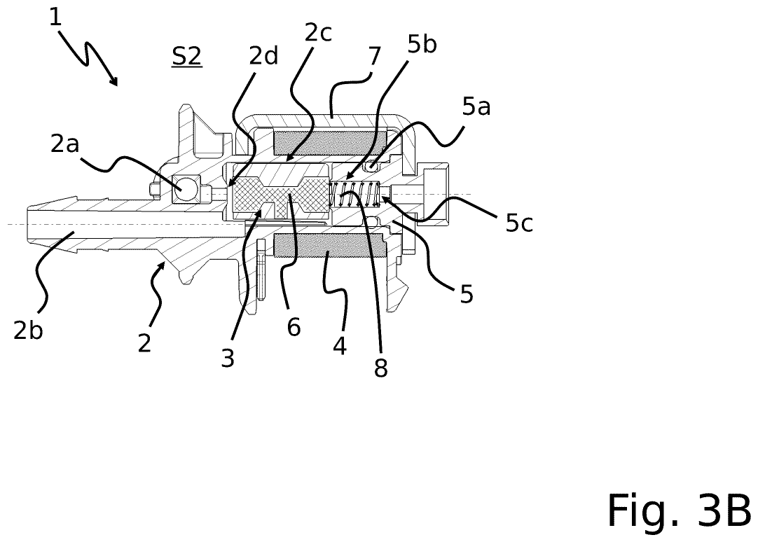

The valve 1 is opened and closed via a piston 3 shown here outside the base body 2. The valve 1 further comprises a coil 4, which is arranged around a portion of the base body 2, and an end stop 5. The base body 2 can also be referred to as a coil carrier. In the assembled state, the end stop 5 is connected to the base body 2 by a C-shaped clamp 7 and is thus fixed in its position, as can be seen in FIGS. 3A and 3B described in more detail below.

As can be seen, the base body 2 has a cylindrical channel 2c, via which a fluid-conducting connection exists between the two openings 2a, 2b. In the open state of the valve 1, a fluid pressure P1 applied to the first opening 2a can thus be passed on and be applied as fluid pressure P2 to the second opening 2b. The piston 3 can be pushed into the channel 2c until it rests on a sealing seat 2d of the base body 2. This position of the piston 3 is referred to as its closed position S1 in the context of the invention. In order to seal the channel 2c against an otherwise uncontrolled escape of fluid, the end stop 5 has a circumferential ring seal 5a, for example in the form of a sealing cord.

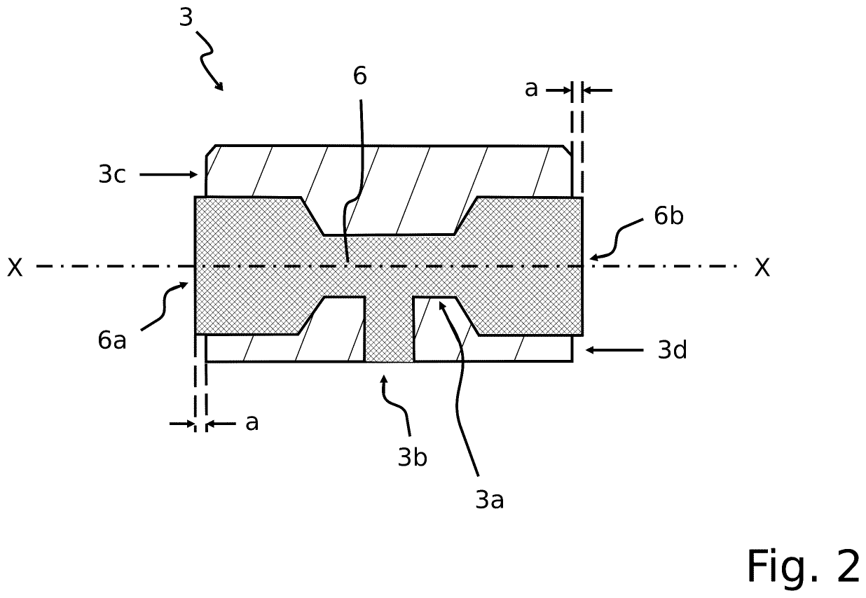

When looking at the piston 3, it becomes clear that it is equipped with a damping element 6. The damping element 6 is at least partially made of a material that is softer than the piston 3, in order to effectively mitigate an impact of the movable piston 3 on the end stop 5 and the sealing seat. As a result, the clicking noises typical of such a valve 1 during operation and resulting from the movements of the piston 3 can be reduced to a minimum. A spring element 8, which is arranged between the piston 3 and the end stop 5 and in the present case is designed purely by way of example as a helical spring, is used to provide a clamping force loading the piston 3. The structure of the damping element 6 is shown again in detail in FIG. 2 and is described in more detail below.

FIG. 2 shows a side view of the piston 3 separated from the other components of the valve 1. Purely by way of example, said piston has a continuous channel 3a, through which the damping element 6 extends. Preferably, the damping element 6 made of a preferably elastically hardened and initially shapeless material can be introduced into the channel 3a of the piston 3. As shown purely by way of example in FIGS. 3A and 3B, for this purpose the piston 3 can have an access 3b, which is connected to the channel 3a and through which the initially shapeless material can be introduced until it fills the entire channel 3a. It can be seen that, at both ends of the piston 3 opposite one another in the longitudinal direction X of the piston 3, a portion 6a, 6b of the damping element 6 in each case protrudes beyond the respective end-face region 3c, 3d. This ensures that the linearly movable piston 3 cannot come into contact with the sealing seat 2d and the end stop 5, which would generate clicking noises, but is always spaced away from them via the respective protruding portion 6a, 6b of the damping element 6. The length a, i.e. the distance between an end-face region 3c, 3d of the piston 3 and a free surface, of the respective portion 6a, 6b of the damping element 6 can be the same toward the two ends of the piston 3.

It can be seen that both protruding portions 6a, 6b of the damping element are unsupported on the circumference, preferably all the way around. This allows the respective portion 6a, 6b of the damping element to deform freely radially when a compressive force acts on it, in order to reduce the impact noise as much as possible by means of its elastic radial deformability.

FIG. 3A shows the valve 1 from FIG. 1 in its assembled and thus operational state in a longitudinal section. As can be seen, the piston 3 is arranged linearly movably within the cylindrical channel 2c of the base body 2. In its closed position S1 shown here, the piston 3 is firmly pressed against the sealing seat 2c of the base body 2. As a result, the two openings 2a, 2b are separated from each other so that no fluid can flow; the valve 1 is in its closed state. The clamping force required to press the piston 3 is built up by the spring element 8, which is arranged for this purpose in a recess 5b of the end stop 5 and is thus supported on the one hand on a bottom 5c of this recess 5b and on the other hand on an end of the piston 3 or on its damping element 6 facing the end stop 5. In this arrangement, the damping element 6 is designed to generate the clamping force acting on the piston 3. The displacement of the piston 3 is effected by applying a voltage to the coil 4, which is part of an electromagnetic drive.

FIG. 3B again shows the valve 1 from FIG. 3A with a changed position of the piston 3. With regard to the representations in FIGS. 3A and 3B, the piston 3 is now displaced to the right into an open position S2. The displacement of the piston 3 is the result of supplying the coil 4 with voltage. The current flowing through the coil 4 creates a magnetic field, which is strongest within the coil 4 and moves the preferably ferromagnetic piston 3 against the clamping force of the spring element 8 from its closed position S1 (see FIG. 3A) into its open position S2 shown here and thus connects the two openings 2a, 2b to one another in a fluid-conducting manner.

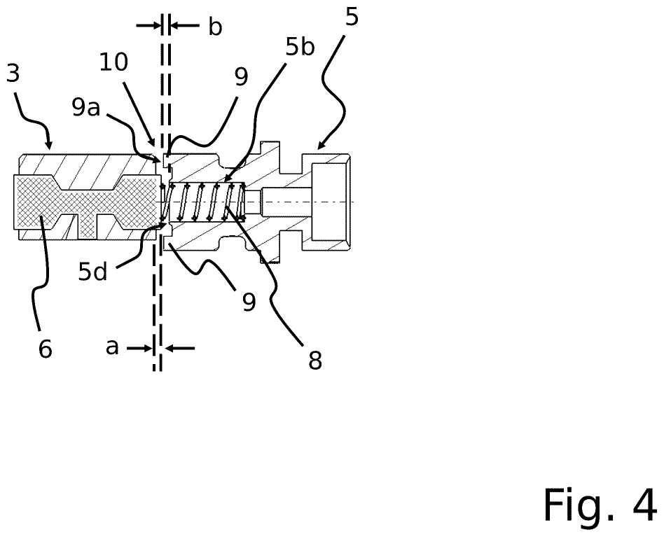

FIG. 4 illustrates an essential embodiment of the valve 1 according to the invention with the aid of its representation in a longitudinal section reduced to only the piston 3, together with its damping element 6, and the end stop 5, together with the spring element 8. In the exemplary embodiment shown here, the end stop 5 has a compensating element 9. The compensating element 9 is located at an end of the end stop 5 facing the piston 3. As can be seen, the compensating element 9 protrudes with its width b relative to the end of the end stop 5. The width b means the distance between a frontmost surface 9a of the compensating element 9 and a surface area 5d of the end stop 5 which protrudes the furthest in the direction of the piston 3. In the present case, the surface area 5d is in the form of an elevation around the entrance of the recess 5b of the end stop 5 in which the spring element 8 is arranged.

The advantage of the compensating element 9 is the at least partial bridging of the annular gap 10 that arises between the end-face region 3d of the piston 3 and the end stop 5. The annular gap 10 is created since, in the open position S2, the piston 3, due to the protruding portion 6b of the damping element 6, is inevitably spaced away from coming into contact with the surface area 5d of the end stop 5 in this case.

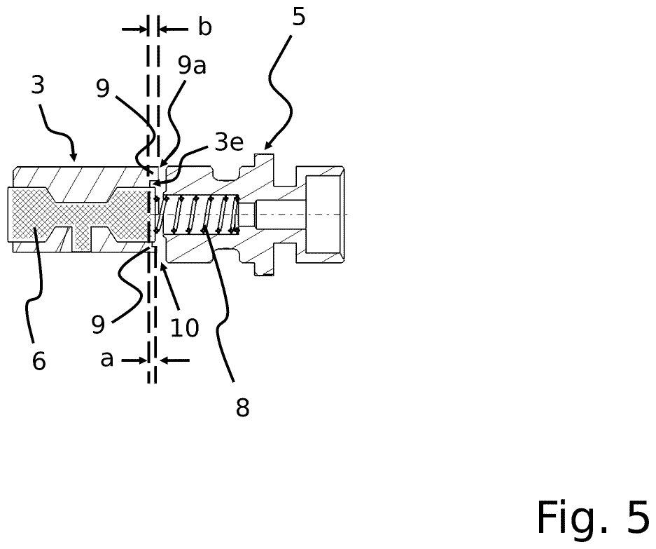

FIG. 5 shows an alternative embodiment of the compensating element 9. As in FIG. 4, for reasons of clarity, the valve 1 is also shown here in a representation in a longitudinal section reduced to only the piston 3, together with its damping element 6, and the end stop 5, together with the spring element 8. It can be seen that the compensating element 9 is now arranged on the piston 3, preferably on the end-face region 3d thereof. The width b of the compensating element 9 means the distance between the frontmost surface 9a of the compensating element 9 and a surface area 3e of the piston 3 which protrudes the furthest in the direction of the end stop 5. In the present case, the surface area 3e is, purely by way of example, identical to the end-face region 3d of the piston 3.

With respect to the longitudinal direction X of the piston 3, the particular length a of the portion 6a, 6b of the damping element 6 protruding relative to the corresponding end-face region 3c, 3d of the piston 3 is in all embodiments less than a width b of the corresponding, preferably associated, compensating element 9. This ensures that the piston 3 always contacts the end stop 5 and the sealing seat 2d via its damping element 6 and that no materials that are hard in comparison thus collide with one another. Due to the compensating element 9, the strongest possible magnetic field can be maintained inside the valve 1 despite the protruding damping element 6.

It is also conceivable that the compensating element 9 is arranged in a manner not shown in detail on an end of the piston 3 facing the sealing seat 2d or on the sealing seat 2d itself. The compensating element 9 may at least partially also be a separate component. Of course, combinations of the above are also possible.

Preferably, the particular compensating element 9 can be ring-shaped in order to reduce the annular gap 10 as consistently as possible and without any interruptions.

Advantageously, the compensating element 9 can at least partially be formed from or comprise a metallic or/and magnetic or/and ferromagnetic material.

Particularly preferably, and as shown in FIG. 4 and FIG. 5, the compensating element 9 can be a one-piece component of the piston 3 or/and of the end stop 5 made of the same material. Alternatively or additionally, the compensating element 9 can of course also be a one-piece component of the sealing seat 2d made of the same material (not shown in detail here).

### LIST OF REFERENCE SIGNS

1 Valve
2 Base body of 1
2a First opening of 2
2b Second opening of 2
2c Channel in 2
2d Sealing seat of 2
3 Piston of 1
3a Channel of 3
3b Access of 3
3c End-face region of 3
3d End-face region of 3
3e Surface area of 3
4 Coil of 1
5 End stop of 1
5a Ring seal of 5
5b Recess in 5
5c Bottom of 5b
5e Surface area of 5
6 Damping element of 1
6a Protruding portion of 6
6b Protruding portion of 6
7 Clamp of 1
8 Spring element of 1
9 Compensating element of 1
9a Surface of 9
10 Annular gap of 1
a Length of 6a and/or 6b
b Width of 9
P1 Fluid pressure
P2 Fluid pressure
S1 Closed position of 3
S2 Open position of 3
X Longitudinal direction of 3

What is claimed is:

1. A valve, preferably a solenoid valve, for a seat comfort system, preferably a vehicle seat comfort system, which in particular comprises at least one fluid actuator, or/and a seat, preferably a vehicle seat, which is equipped with such a comfort system, the valve comprising a base body with a linearly movable piston, which is reversibly displaceable in the direction of a sealing seat and in the direction of an end stop, wherein the piston has at least one damping element provided for mitigating its impact on the end stop or/and on the sealing seat, and the piston has a channel extending through it between two end-face regions of the piston, wherein the damping element is arranged within this channel.

2. The valve according to claim 1, further comprising at least one end-side portion of the damping element that protrudes relative to the preferably respectively associated end-face region of the piston, preferably to form an annular gap spacing the piston, preferably in a closed position, away from the sealing seat or/and, preferably in an open position, away from the end stop.

3. The valve according to claim 1, wherein the piston is reversibly displaceable by a preferably electromagnetic drive against the clamping force in the direction of the end stop for reaching an open position and, preferably by the clamping force, in the direction of a sealing seat for reaching a closed position.

4. The valve according to claim 2, further comprising at least one compensating element structured to partially bridge the annular gap, such that, with respect to a longitudinal direction (X) of the piston, a length (a) of a portion (6a, 6b) of the damping element protruding relative to the in particular associated end-face region of the piston is less than a width (b) of the in particular associated compensating element.

5. A valve, preferably solenoid valve, for a seat comfort system, preferably a vehicle seat comfort system, which preferably comprises at least one fluid actuator, or/and a seat, preferably a vehicle seat, which is equipped with such a comfort system, the valve comprising a base body with a linearly movable piston, which is reversibly displaceable by means of a clamping force into a closed position pressing the piston against a sealing seat and, for reaching an open position, by means of an electromagnetic drive against the clamping force in the direction of an end stop, wherein the piston has at least one damping element provided for mitigating its impact on the end stop or/and on the sealing seat, which damping element protrudes relative to an end-face region of the piston to form an annular gap spacing the piston in a closed position away from the sealing seat or/and in its open position away from the end stop, further comprising at least one compensating element designed to partially bridge the annular gap, such that, with respect to a longitudinal direction (X) of the piston, a length (a) of a portion (6a, 6b) of the damping element protruding relative to the preferably associated end-face region of the piston is less than a width (b) of the preferably associated compensating element.

6. The valve according to claim 5, wherein at least part of the compensating element(s) (9) is/are arranged or formed on the piston (3) or/and on the sealing seat (2d) or/and on the end stop (5).

7. The valve according to claim 5, wherein the damping element is arranged or formed within the piston, wherein the protruding portion(s) of the damping element is/are located outside the piston.

8. The valve according to claim 5, wherein the damping element is made of a preferably elastically hardened and initially shapeless material and is introduced into a channel of the piston.

9. The valve according to claim 5, wherein the compensating element(s):
a) is/are at least partially formed from or comprises/comprise a metallic or/and magnetic or/and ferromagnetic material; or/and
b) is/are a one-piece component of the piston made of the same material; or/and
c) is/are a one-piece component of the sealing seat (2d) made of the same material; or/and
d) is/are a one-piece component of the end stop (5) made of the same material.

10. The valve according to one of claims 5, wherein a clamping force acting on the piston is generated by a spring element, preferably a helical spring.

11. The valve according to claim 5, wherein the piston has a channel extending through the piston between its two end-face regions, wherein the damping element is arranged within this channel, or the piston has an access, which is connected to the channel, in particular arranged on the circumference of the channel, and through which the damping element is introduced as an initially shapeless material, preferably completely filling the channel.

12. The valve according to one of claim 1, wherein the channel widens toward at least one, preferably both, end-face region(s) of the piston.

13. The valve according to one of claim 8, wherein the channel widens toward at least one, preferably both, end-face region(s) of the piston.
